(19) United States
(12) Patent Application Publication
(10) Pub. No.: US 2013/0305925 A1
(43) Pub. Date: Nov. 21, 2013

(54) METHOD AND SYSTEM TO CAPTURE CO2

(71) Applicant: ROBERT B. POLAK, New York, NY (US)

(72) Inventor: ROBERT B. POLAK, New York, NY (US)

(21) Appl. No.: 13/897,410

(22) Filed: May 19, 2013

Related U.S. Application Data
(60) Provisional application No. 61/649,356, filed on May 20, 2012.

(51) Int. Cl. B01D 53/14

(52) U.S. Cl. CPC B01D 53/1475
USPC 95/227; 96/243

(57) ABSTRACT

A method is disclosed herein. The method includes the step of capturing and concentrating CO₂ from atmospheric air by utilizing geothermal heat to provide the energy needed to move the atmospheric air through a tower.

### CROSS-REFERENCE TO RELATED APPLICATIONS

This application claims the benefit of U.S. Provisional Patent Application Ser. No. 61/649,356 for a NOVEL SYSTEM TO CAPTURE CO₂ ANYWHERE IN THE WORLD, filed on May 20, 2012, which is hereby incorporated by reference in its entirety.

### BACKGROUND OF THE INVENTION

1. Field of the Invention

The invention relates to carbon dioxide (hereafter CO₂) capture systems.

2. Description of Related Prior Art

U.S. Pub. No. 2008/0138265 discloses SYSTEMS AND METHODS FOR EXTRACTION OF CARBON DIOXIDE FROM AIR. The '265 publication describes methods and systems for extracting, capturing, reducing, storing, sequestering, or disposing of carbon dioxide (CO₂), particularly from the air. The CO₂ extraction methods and systems involve the use of chemical processes. Methods are also described for extracting and/or capturing CO₂ via exposing air containing carbon dioxide to a solution comprising a base-resulting in a basic solution which absorbs carbon dioxide and produces a carbonate solution. The solution is causticized and the temperature is increased to release carbon dioxide, followed by hydration of solid components to regenerate the base.

### SUMMARY OF THE INVENTION

In summary, the invention is a method for capturing CO₂. The method includes the step of capturing and concentrating CO₂ from atmospheric air by utilizing geothermal heat to provide the energy needed to move the atmospheric air through a tower.

### BRIEF DESCRIPTION OF THE DRAWINGS

FIG. 1 is a schematic diagram of a first process according to an exemplary embodiment of the invention; and

FIG. 2 is a schematic diagram of a second process according to an exemplary embodiment of the invention.

### DETAILED DESCRIPTION OF EXEMPLARY EMBODIMENTS

The need for ever-increasing energy consumption is generally considered to be essential by all of today's developed and developmentally aspiring societies. In addition to the growing demand for energy in the developed nations, many societies are on the cusp of achieving a more advanced stage of economic development, which is only possible with increased consumption of energy. Because of these and other developments, the inventor has perceived that there is increasing demand for all types of fossil fuels in general and petroleum in particularly throughout the world. Many oil fields are depleted or can remain productive only with enhanced oil recovery (EOR) technologies. While EOR has been in use for over forty years it is now finding greater acceptance throughout the world.

To understand how EOR fits into an oil field development we must consider the stages of an oil field's productive life. When a field is first brought into production, oil flows naturally to the surface due to existing reservoir pressure. As reservoir pressure drops with extraction of oil, water is typically injected to boost the pressure needed to displace the oil—this is the secondary phase of the process. Finally still more oil can be recovered usually by injecting CO₂ during the tertiary or enhanced oil recovery (CO₂-EOR) phase of operations.

It should be understood that today CO₂-EOR is a very important part of the overall operation and economics of an oil field. The first phase of the operation is highly productive and exciting but it only recovers about 6 to 15% of the “Original Oil in Place” (OOIP). The secondary (the introduction of water) phase which is also important can recover an additional 6 to 30% of the OOIP. Depending on its geology and other factors this can still leave 55 to 88% of the OOIP in the ground. It is at this stage that CO₂-EOR is introduced into the process where it can recover an additional 8 to 20+% of the OOIP. This step is very important for extending the economic life of the field but it is also very expensive. Even with this effort at least 35% of the OOIP is still left in the ground.

As part of the EOR process when CO₂ is injected in the formation it enters into the pore spaces of the rocks helping the crude oil to get out. Two characteristics of CO₂ that make it a good choice for this purpose: first it is miscible with crude oil; and second it is less expensive than other similarly miscible fluids.

Thus when CO₂ is injected into an oil reservoir, it becomes mutually soluble with the residual crude oil as light hydrocarbons from the oil dissolve in the CO₂ and CO₂ dissolves in the oil. This occurs most readily when the CO₂ density is high (when it is compressed) and when the oil contains a significant volume of “light” (i.e., lower carbon) hydrocarbons (i.e. typically a low-density crude oil). CO₂ injection is expensive, often equal to about 50% of the value of the additionally extracted EOR oil, so optimizing the ratio of CO₂ injected to oil recovered has been an important consideration. However, as the price of oil goes up and the cost of CO₂ comes down it may be economical to use more CO₂ to recover a greater share of the remaining oil. In addition, should economic value be placed on sequestration of the CO₂ it may become advantageous to maximize the injection of CO₂ into oil fields while recovering an increased fraction of the OOIP.

Today the United States leads the world in both the number of CO₂-EOR projects and in the volume of CO₂-EOR oil production, in large part because some of U.S. geology is favorable, many of its oil fields are aging, and large sources of natural, high purity CO₂ are relatively close-by. Both in the U.S. and throughout the world, a growing number of CO₂-EOR projects are being launched at many sites of aging oil fields. However, since low cost CO₂ is not readily available in many locations this transition has been slowed down.

At this stage of development CO₂-EOR is undoubtedly the largest market for CO₂, with carbonated beverages a distant second, followed by a variety of still smaller food, chemical and miscellaneous applications. Since the U.S. leads in CO₂-EOR technology it is probably the largest commercial consumer of CO₂. To date the U.S. has used about 560 million metric tons of CO₂ for EOR. And while this is far less than the US industrial emission of CO₂ (i.e. 5,090 million metric tons/year) it is still a large number.

Most CO₂-EOR operators purchase CO₂ from natural geologic sources, and to a far lesser extent from CO₂-emitting industries, but with most of the CO₂ delivered by pipeline the cost of transportation is still relatively high. For example, pipelines constructed in the late 1970s and early 1980s to connect Permian Basin oil with natural underground CO₂ sources in Colorado and New Mexico cost more than $1 billion at that time but would cost much more today. Yet even though these locations are only a few hundred miles from its users their transportation cost is typically $0.25-0.75/thousand cubic feet of CO₂ (i.e. $4.81 to 14.44/metric ton). Almost all other consumers (even large ones) have their CO₂ delivered by truck and pay far more for it than EOR consumers.

Thus, the cost of CO₂, when dominated by transportation costs, is a problem that limits CO₂-EOR to relatively few of the many aging oil fields around the world. Clearly, it would be desirable to eliminate the need for having to ship CO₂ long distances by pipeline or even worse by truck. A solution to this problem is direct atmospheric capture of CO₂ (DAC) as this is available uniformly everywhere. The prevailing view now is that DAC is not feasible. This view is based on the assumptions that DAC would need a large amount of energy and be excessively costly because of the need to move the vast quantities of air required to extract the less than 400 ppm of CO₂ from the atmosphere. Those assumptions have led to the conclusion that DAC cannot be economically employed for CO₂-EOR or any other purpose.

However, those assumptions are challenged by the DAC work being done by several researchers (i.e. Polak and Steinberg, Lackner, Eisenberger and Keith). While progress has been made to significantly reduce the costs of DAC, so far none of these investigators have been able to identifying a process that would: (1) operate continuously 24/7 (not intermittently) (2) achieve acceptably low cost; and (3) be located almost anywhere in the world.

Polak and Steinberg solved the cost problem (see Patent Application US 2012/0003722) by utilizing existing infrastructure and waste/low-cost heat available at existing industrial facilities such as thermoelectric power plants and other large energy related operations (e.g. petroleum refineries, petrochemical plant and cement manufacturers). They accomplished this by “piggybacking” on facilities that were originally built and continue to be used for other purpose(s), but now could also capture CO₂ at low cost without materially effecting existing operations. Since these host facilities are usually round-the-clock operations, the add-on CO₂ capture facility would operate 24/7 as well. Since such plants are found throughout the world the CO₂ capture could be widely dispersed. However, it is unlikely that these host plants would be optimally co-located in relation to their potential CO₂ customers such as aging oil fields.

This co-location problem could be minimized, or entirely eliminated, if it were possible to cut the umbilical cord between the Polak and Steinberg DAC system and their industrial host facilities without sacrificing the inherent cost advantage which they would otherwise enjoy. But to do that, another inexpensive source of energy broadly available throughout the world would be required.

A new approach for providing the energy must be found to make this viable. Surprisingly, Enhanced Geothermal System (EGS) could make such a system, with all these desired characteristics, economically viable right at an oil field site or anywhere else.

The idea at the heart of EGS is rather simple but its execution can be complex. EGS power works by tapping into the energy of the earth itself to produce clean, reliable power that does not exploit natural resources and will be around for future generations. Unlike fossil fuel energy sources (oil, natural gas, and coal) geothermal energy is carbon neutral making it an important tool and energy source in controlling greenhouse gasses (GSG). The only by-product of power generation is water steam, which is cooled and then with the remainder of water, re-injected back into the reservoir. However it has been proposed that CO₂ could be used as a heat transmission fluid that might produce better results and would also be reinjected into the reservoir. Also, unlike other renewable energy sources, EGS can be used for 24/7 baseload power since it doesn't swing with external conditions as do solar or wind power.

Recent research from SMU's Geothermal Laboratory, funded by a grant from Google.org, documents there are significant geothermal resources across the United States capable of producing more than three million megawatts of green power—10 times the installed capacity of coal power plants today. For more information see http://blog.google.org/2011/10/new-geothermal-map-of-united-states.html. But accessing the energy in deep, hot rock isn't as easy as might at first appear, as can be inferred from the fact that to date no commercial plants have been built even though EGS research & development has been underway for more than 30 years.

The reason for this is that EGS attempts to artificially reproduce the conditions of naturally occurring hydrothermal reservoirs by fracturing impervious hot rocks at great depths, pumping fluid into the newly porous system, and then extracting the high temperature heated fluid to drive an electricity-generating turbine. The most difficult elements of this process are the creation of the hydrothermal reservoir and a flow of fluid—typically water—through the fractured rock. However, the hot rocks best suited for EGS are rarely porous enough, as they are buried so deep that they become compressed by the weight of the earth. As a result, EGS must increase the natural porosity of a geological structure by injecting highly pressurized water—a process often referred to as “stimulation.” While these drilling techniques are similar to those used by the oil and gas industry, in order to generate electricity EGS must operate at greater depths (i.e. ˜6 km+) and higher temperatures (i.e. >250° C.) than those required in the oil & gas business. Because of these extreme conditions more problems are encountered with greater frequency, resulting in well failure due to collapse, mechanical malfunction, loss of telemetry and casing failure. Also, even though it is well known that the earth's temperature increases on average by ˜25 to 30° C./km of depth, the actual temperature at any location can vary significantly from that norm depending on geology and prior earth history (e.g. volcanic activity), etc. And since EGS is looking for very high temperatures which at best occur at depth near or in excess of current drilling capabilities, a small distance from an optimal location may result in failure.

Because of all the development work that still has to be done, commercialization of the high temperature EGS process probably won't be ready for years. However, since we only require working temperature of ˜100° C. for our DAC system, obtaining and using a modified EGS as a source of low temperature heat should be relatively trouble free for the following reasons.

Since operating temperatures of only ˜100° C. is required and since such temperatures are generally available at depth of 2 to 4 km below ground level, it shouldn't be a problem to find such locations.

Temperatures of ˜100° C. or possibly even 130° C. or more are typically found at 2 to 4 km depth holes drilled at many oil development/production sites that shouldn't be a problem.

Current oil fields are already operating at temperatures and pressures required by our low temperature modified-EGS should not result in excessive corrosion, temperature, and other operating problems experienced by high temperature EGS operations.

Relatively shallow wells that could produce ˜100° C. or possibly even 130° C. or more water should be readily identifiable in the US “oil patch” and throughout the world where they would be needed.

Among the thousands of abandoned, nearly abandoned or unproductive oil wells (in the US & other locations) there are many wells that could be repurposed to produce hot water—rather than the oil that they were previously intended to produce. Thus for example, there are not only many unproductive bore holes that are already drilled in oil fields of Texas, but many of them also have verified thermal and geological information. Retooling these wells to produce hot water could greatly accelerate the entire process and also reduce upfront capital and operating costs.

In the future, should technology advance to the point where EGS can produce high temperature steam which could economically generate electricity we could use the low temperature waste heat (˜100° C.) from the electrical generator to power our system to capture the CO₂ as described below.

Broadly speaking the process is designed to capture and concentrate CO₂ from the atmosphere by utilizing “low-grade EGS heat” (“EGS” or “EGS heat”) to power “pseudocooling tower(s)” (the “tower” or “pseudotower”) and the rest of the CO₂ capture system. This can be done in a number of ways, including but not limited to, the two described below.

In a first embodiment, a first stream of water is pumped down into the ground in a pressurized pipe through a shaft such as is defined by a depleted oil well, into contact with geothermally heated earth that heats the water to 100° C. or higher. The pressurized hot water is brought out of the ground and directed to a heat exchanger where the pressure is reduced and the water flashes into steam. The volume of steam entering the heat exchanger is controlled to allow the steam to condense to water in the heat exchanger. This water recirculates to the geothermal heat source in the well. Heat from the first stream of water is transferred to a second stream of water (which is isolated from the first stream of water) within the heat exchanger. The second, hot stream of water from the heat exchanger is sprayed down through a relatively small/inexpensive tower. This hot water spray heats the air within the tower causing a convection current of heated air to rise up out of the tower pulling ambient air in at the bottom of the tower. The air entering at the bottom of the tower is drawn by convection up through the tower. While a typical cooling tower is designed to optimize heat loss our tower need not be constrained this way. Thus the tower dimensions and the ΔT (i.e. the difference between top and bottom temperature) could be adjusted to minimize its cost and maximize CO₂ capture unconstrained by the need to maximize heat loss. Water that falls through the tower is collected and recirculates through the heat exchanger. In this configuration of the invention, a reaction chamber is located so that air drawn into the tower passes through the reaction chamber before the air enters the tower. In the reaction chamber the air passing through comes into contact with an aqueous absorbent solution containing K₂CO₃ or possibly another carbonate(s) (“carbonate(s)”) and KHCO₃ or the bicarbonate(s) that would be formed from another carbonate(s) (“bicarbonate(s)”). K₂CO₃ is not the only carbonate that can be used this way (for example NaCO₃ will also work). The concentrations of the carbonate and bicarbonate are slightly below the chemical saturation point. In the reaction chamber atmospheric CO₂ reacts with K₂CO₃ in the absorbent solution to produce a KHCO₃ precipitate in accordance with the following equation:

K₂CO₃+CO₂+H₂0→2KHCO₃↓

The reason that KHCO₃ precipitates selectively from solution is that it is far less soluble than K₂CO₃ over a range of temperatures (see table below).

Comparison of K₂CO₃ & KHCO₃ Solubilities at 20° C. & 100° C.
(g/100 ml H₂0)

| | at 20° C. | at 100° C. |
|---|---|---|
| K₂CO₃ | 112.0 | 156.0 |
| KHCO₃ | 22.4 | 60.0 |

In some locations geothermal wells produce hot water from subterranean water sources. In such cases, water may flow from the geothermal well to the heat exchanger then may either be returned to the geothermal source or otherwise disposed of.

Following CO2 absorption into the absorbent solution and formation of the bicarbonate precipitate the precipitate is then separated at separator 48 as a wet slurry from the absorbent solution before entering a heater 50 or reactor heated to ˜90-100° C. At this temperature the KHCO₃ is thermally decomposed so as to regenerate the K₂CO₃. This K₂CO₃ is mixed with the absorbent solution to bring the K₂CO₃ concentration back up to near the point of chemical saturation. The reconstituted absorbent solution is returned to capture more CO₂. At the same time the CO₂ which is liberated may be dried to remove any residual water and sent to storage or use. This reaction is described as follows:

2KHCO₃→K₂CO₃+H₂0+CO₂↑

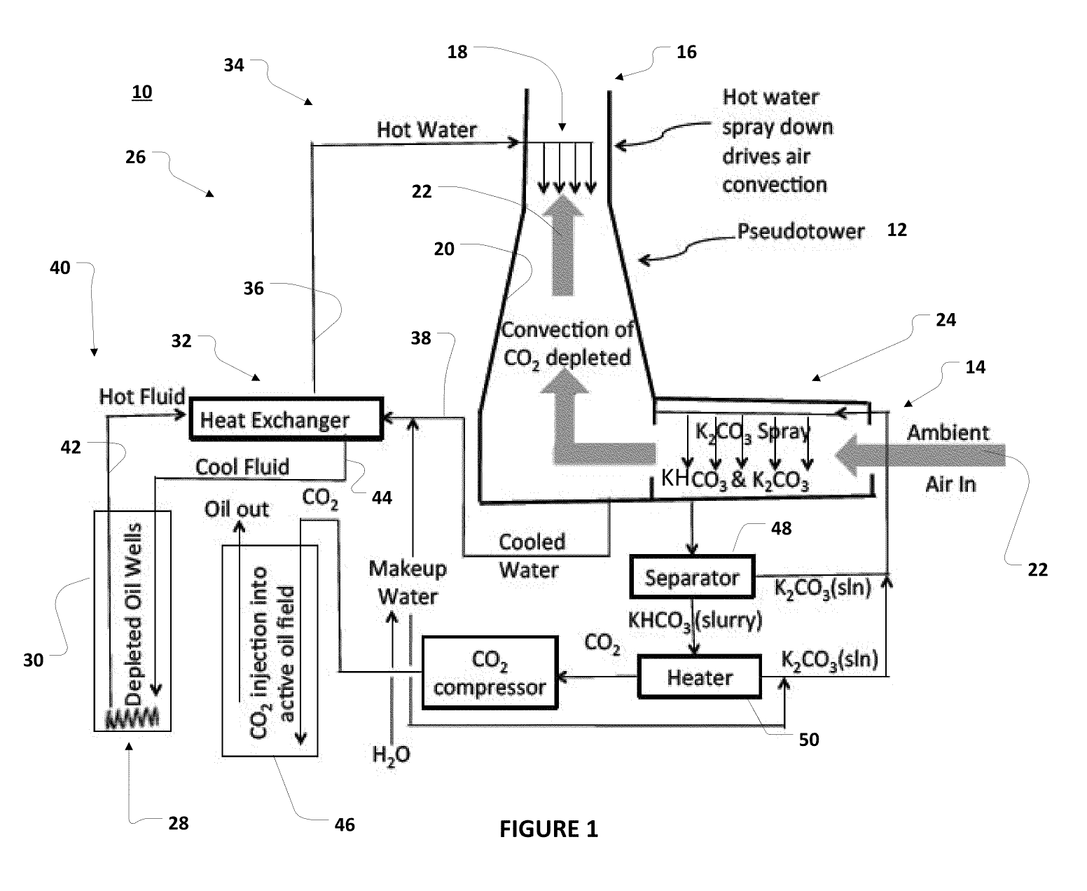

The air stripped of its CO2 as indicated above is vented out of the top of the tower. A schematic diagram of the process is provided in FIG. 1.

In a second embodiment, the heat from the hot water from the heat exchanger is delivered to the tower and circulated through a gas/liquid heat exchanger(s) (e.g. radiator) which is positioned near the top of the tower. Here the hot water is never in physical contact with the air at this level of the tower but nonetheless the heat that is provided near the top of the tower warms the air and drives convection of air up through the tower. In this configuration a number of sprayer heads would be positioned near the top of the tower (below the heat exchanger) that would deliver a downward spray of concentrated K₂CO₃ and KHCO3 absorbent solution through the rising air that will react with the CO₂ in the air to produce a KHCO₃ precipitate in the absorbent solution that collects at the bottom of the tower. The precipitate passes from the tower as wet slurry along with any residual liquid at the bottom of the tower. Once the slurry is formed and exits the tower it is separated in a separator 48a from the residual liquid and the remaining steps in the process of producing CO₂ and recirculating the reactant is substantially the same as that described above in the first embodiment, but a thermal decomposition 52a stage is also applied. Here again the spent air is vented from the top of the tower.

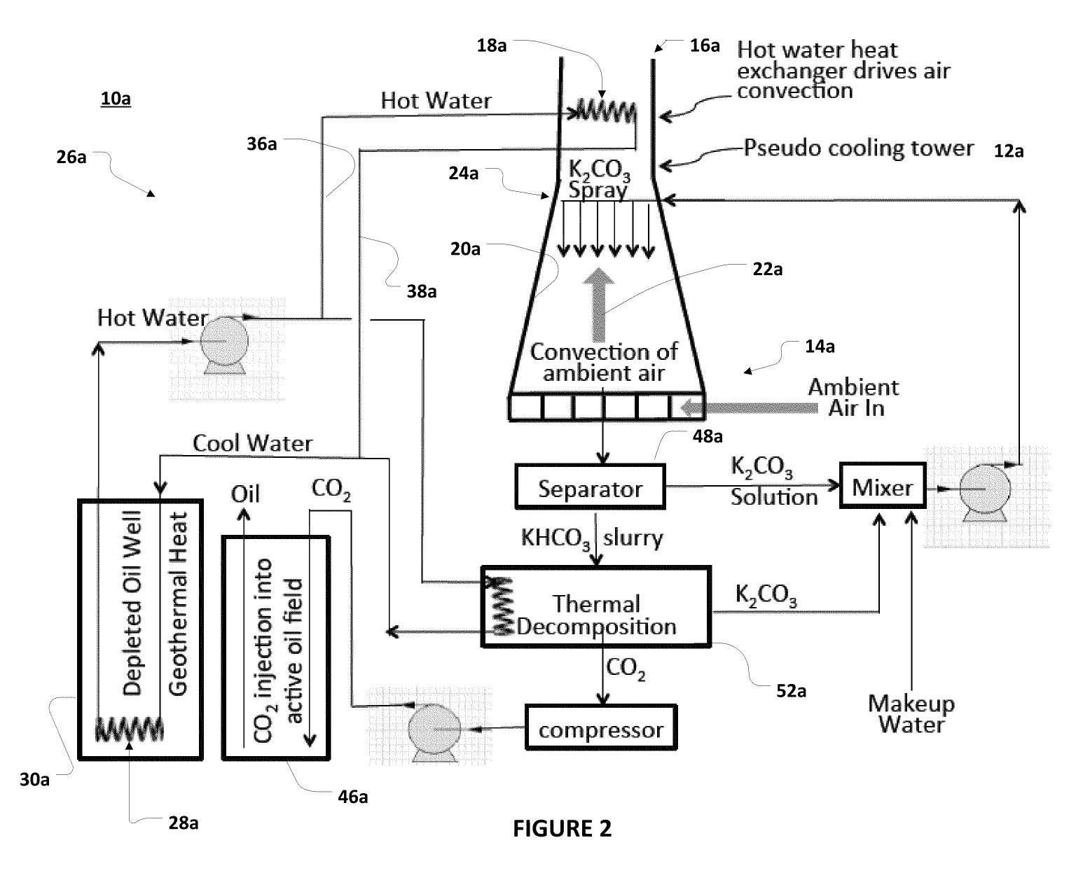

A schematic diagram of this process is provided in FIG. 2.

It should be noted that since the entire CO₂ process cycle outlined above requires relatively little thermal energy the relatively low temperature EGS heat from shallow geothermal wells (or depleted oil wells) would provide enough energy to power both air convection within the tower and the rest of the CO₂ capture cycle.

The low energy requirement for thermal decomposition of KHCO₃ and the reuse of the K₂CO₃ are critical factors for the low cost of the overall process. Moreover, since K₂CO₃ does not degrade when it is exposed to these conditions for an extended period of time it can be reused over and over again.

Under normal circumstances K₂CO₃/KHCO₃ system's CO₂ capture reaction kinetics (i.e. the equation set forth in paragraph [0032]) is the rate limiting step for the entire process. But our analysis indicates that the kinetics can be improved in three ways: (1) increase the contact time and interface contact area between the liquid and gas phases of the reaction; (2) raise the pH of the reaction; and (3) utilize a catalyst and/or enzyme that will improve reaction kinetics.

In order to obtain the largest contact interface and longest possible contact time between the gas phase and the liquid phase the K₂CO₃ solution is continuously injected into the column or some similar reactor through one or more spray nozzles that create small droplets at or near the top of the reactor vessel. These droplets fall toward the bottom of the reactor vessel through a rising stream of gas (e.g. air) which contains the CO₂. The gas enters at the bottom of the reactor and rises towards an exit at the top. CO₂ is absorbed from the air into the falling droplets. CO₂ absorbed into the droplets reacts with K₂CO₃ to form KHCO₃. The KHCO₃ precipitates from solution and is carried in the droplets downward to exit near the bottom of the reactor. The liquid phase enters at or near the top of the reactor through spray nozzles. The nozzles create drops with the largest possible surface area per unit weight of solution but that are not so small that they will be blown out the top of the reactor by the rising stream of air. The optimum size of the droplet will be determined empirically.

The reactor may be configured in any one of several geometries. Generally, the best results will be obtained by: a) having liquid and gas streams move past each in the vertical plane (in counter-current flow) within the reactor; or b) liquid phase moves vertically downward through a horizontally moving gas phase (cross-current flow); and c) in some configurations with both liquid and gas move through the reactor in the same direction and in the same plane (co-current flow). Packing material may be added to the reactor to improve surface area for contact between liquid and gas phases or to facilitate enzyme or catalyst functioning within the reactor.

The pH of the liquid phase may be raised to facilitate the overall kinetics. The idea is to provide conditions favoring the most rapid rates of absorption of CO₂ and reaction and the lowest possible cost.

The solution of K₂CO₃ and KHCO₃ delivered to the reactor vessel will have concentrations close to the level at which it will rapidly form the KHCO₃ precipitate once it comes in contact and reacts with the CO₂ from the gas (e.g. air) but not so concentrated that it will form a precipitate of K₂CO₃ alone. The pH and concentrations must be carefully controlled by an automated system that not only takes into consideration these parameters but also the operating temperature (see table above) of the system that affects the solubility of both compounds.

Catalysts and/or enzymes may be used to improve the CO₂ absorption kinetics. A number of amine and other organic compounds were used over the years for this purpose with limited success. However most attention has been focused on Carbonic Anhydrase enzyme (CA) for this purpose because of the good record it has had as a biological enzyme used for this purpose. But the problem has been that it has inability to withstand industrial processing conditions. However, recently a new exciting catalyst development has come into view which might change this situation. Researchers at University of Newcastle upon Tyne have recently reported that Nickel (Ni) catalyst significantly increase the rate of absorption of CO₂ in water. Since Ni is much less expense and far more stable (unaffected by pH) than CA and is ferromagnetic which would allow it to be readily separated from other material it might significantly improve reaction kinetics.

Therefore such Ni catalyst could be utilized in several forms in our system including but not limited to: (a) incorporated as Ni nanoparticles in the concentrated K₂CO₃ spray that enters our reactor (as previously described) and then separated ferromagnetically (and ready to be reused) from the rest of the material before or after the KHCO₃ precipitate is decomposed; (b) the Ni could be immobilized on one of a number of substrates and added to or otherwise incorporated to the packing in the reactor; (c) drawn into pure Ni or high Ni alloy wires which could be woven into catalytically activity screen in the reactor; (c) apply the Ni as coating on suitable solid metal, plastic or other materials that could be fashioned into any number of forms which could be used that could be used to catalyze the process.

A plurality of different embodiments of the invention is shown in the Figures of the application. Similar features are shown in the various embodiments of the invention. Similar features have been numbered with a common reference numeral and have been differentiated by an alphabetic suffix. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

FIG. 1 shows a first embodiment of a system 10 for capturing CO₂. A tower 12 has at least one inlet 14 and at least one outlet 16 positioned above the inlet 14. A first heat transfer structure 18 is positioned in an interior 20 of the tower 12 closer to the outlet 16 than the inlet 14. The first heat transfer structure 18 is operable to drive a flow 22 of atmospheric air through the tower 12 in through the inlet 14 and out of the outlet 16.

A sprayer 24 is positioned in the tower 12. The sprayer 24 is operable to dispense a spray of a first fluid stream containing K₂CO₃ within the tower 12. The first fluid stream comingles with the flow 22 of atmospheric air and captures CO₂ from the flow 22 of atmospheric air. The CO₂ can be captured from the first fluid stream and the captured CO₂ can be directed down an active oil well 46. The first heat transfer structure 18 sprays a second fluid stream into the interior 20. The second fluid stream only includes water in the exemplary embodiment. The tower 12 is arranged such that the first and second fluid streams are prevented from comingling in the interior 20 of the tower 12.

A first fluid circuit 26 is defined in part by the first heat transfer structure 18 and in part by a second heat transfer structure 28. The second heat transfer structure 28 is positioned in a depleted oil well 30 such that at least part of the heat transferred into the interior 20 of the tower 12 is geothermal and drawn from the depleted oil well 30. The heat extracted from the well 30 can be used to induce the flow of atmospheric air through the tower 12.

The first exemplary embodiment includes a third heat transfer structure 32 operably disposed between, or intermediate with respect to the first heat transfer structure 18 and the second heat transfer structure 28. The first fluid circuit 26 includes a second fluid circuit 34 defined in part by the first heat transfer structure 18 and the third heat transfer structure 32 and first and second conduits 36, 38 placing the first heat transfer structure 18 and at least a portion of the third heat transfer 32 structure in fluid communication with one another. The first fluid circuit 26 also includes a third fluid circuit 40 defined in part by the second heat transfer structure 28 and the third heat transfer structure 32 and third and fourth conduits 42, 44 placing the second heat transfer structure 28 and at least a portion of the third heat transfer structure 32 in fluid communication with one another.

FIG. 2 shows a second embodiment of a system 10a for capturing CO₂. A tower 12a has at least one inlet 14a and at least one outlet 16a positioned above the inlet 14a. A first heat transfer structure 18a is positioned in an interior 20a of the tower 12a closer to the outlet 16a than the inlet 14a. The first heat transfer structure 18a is operable to drive a flow 22a of atmospheric air through the tower 12a in through the inlet 14a and out of the outlet 16a. In the second exemplary embodiment, the first heat transfer structure 18a defines an enclosed passageway for fluid to pass into and out of the interior 20a without contacting the interior 20a.

A sprayer 24a is positioned in the tower 12a. The sprayer 24a is operable to dispense a spray of a first fluid stream containing K₂CO₃ within the tower 12a. The first fluid stream comingles with the flow 22a of atmospheric air and captures CO₂ from the flow 22a of atmospheric air. The CO₂ can be captured from the first fluid stream and the captured CO₂ can be directed down an active oil well 46a.

A first fluid circuit 26a is defined in part by the first heat transfer structure 18a and in part by a second heat transfer structure 28a. The second heat transfer structure 28a is positioned in a depleted oil well 30a such that at least part of the heat transferred into the interior 20a of the tower 12a is geothermal and drawn from the depleted oil well 30a. The tower 12a is proximate to the well 30a so that the captured CO₂ need not be shipped from a remote location. The heat extracted from the well 30a can be used to induce the flow of atmospheric air through the tower 12a and also to assist in thermal decomposition of the potassium bicarbonate slurry, separating the carbon dioxide from the potassium carbonate.

First and second conduits 36a, 38a place the first heat transfer structure 18a and the second heat transfer structure 28a in direct fluid communication with one another, without an intermediate heat transfer structure disposed between the first heat transfer structure 18a and the second heat transfer structure 28a.

Most of this discussion has been devoted to the use of this invention for EOR—which is by far the largest commercial consumer of CO₂ today. But clearly the system described here would be equally useful for any other applications where low cost CO₂ is required at various locations throughout the world for commercial use, sequestration or any other applications which may come to light in the future.

Moreover, while this invention has been described in conjunction with the examples cited above, it is apparent that many alternatives, modifications and variations will be evident to those skilled in the art. Accordingly the examples of this invention, as set forth above, are intended to be illustrative, not limiting. Various changes may be made without departing from the spirit and scope of the invention herein claimed.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Further, the “invention” as that term is used in this document is what is claimed in the claims of this document. The right to claim elements and/or sub-combinations that are disclosed herein as other inventions in other patent documents is hereby unconditionally reserved.

What is claimed is:

1. A method comprising the step of:
capturing and concentrating CO₂ from atmospheric air passing through a tower; and
utilizing geothermal heat to provide the energy needed to move the atmospheric air through a tower.

2. The method of claim 1 further comprising the step of:
positioning the tower proximate to an active oil well; and
directing the captured CO₂ down the active oil well.

3. The method of claim 1 further comprising the step of:
using the captured CO₂ in the production of carbonated beverages.

4. The method of claim 1 further comprising the step of:
storing the captured CO₂ in a tank.

5. The method of claim 1 wherein said step of capturing and concentrating CO₂ from atmospheric air further comprises:
comingling the atmospheric air with K₂CO₃ or other carbonates.

6. The method of claim 5 wherein said step of capturing and concentrating CO₂ from atmospheric air further comprises:
spraying K₂CO₃ or other carbonates over a stream of the atmospheric air.

7. The method of claim 5 decomposing KHCO₃ or other carbonates resulting from said comingling step into CO2 for one of immediate use and storage.

8. A system for capturing carbon dioxide (CO₂) comprising:
a tower having at least one inlet and at least one outlet positioned above said inlet;
a first heat transfer structure positioned in an interior of said tower closer to said outlet than said inlet and operable to drive a flow of atmospheric air through the tower in through said inlet and out of said outlet;
a first sprayer positioned in said tower and operable to dispense a spray of a first fluid stream containing K₂CO₃ or other carbonates within said tower, wherein said first fluid stream comingles with the flow of atmospheric air and captures CO₂ from the flow of atmospheric air; and
a first fluid circuit defined in part by said first heat transfer structure and in part by a second heat transfer structure positioned in a depleted oil well such that at least part of the heat transferred into said interior of said tower is geothermal and drawn from said depleted oil well.

9. The system of claim 8 wherein said first heat transfer structure includes a sprayer.

10. The system of claim 8 wherein said first heat transfer structure sprays a second fluid stream into said interior.

11. The system of claim 10 wherein the second fluid stream only includes water.

12. The system of claim 10 wherein said tower is arranged such that said first and second fluid streams are prevented from comingling in said interior of said tower.

13. The system of claim 8 wherein said first heat transfer structure defines an enclosed passageway for fluid to pass into and out of said interior without contacting said interior.

14. The system of claim 8 further comprising:
a third heat transfer structure operably disposed between said first heat transfer structure and said second heat transfer structure.

15. The system of claim 14 wherein said first fluid circuit further comprises:
a second fluid circuit defined in part by said first heat transfer structure and said third heat transfer structure and first and second conduits placing said first heat transfer structure and at least a portion of said third heat transfer structure in fluid communication with one another; and
a third fluid circuit defined in part by said second heat transfer structure and said third heat transfer structure and third and fourth conduits placing said second heat transfer structure and at least a portion of said third heat transfer structure in fluid communication with one another.

16. The system of claim 8 wherein said first fluid circuit further comprises:
first and second conduits placing said first heat transfer structure and said second heat transfer structure in direct fluid communication with one another.

17. A method for capturing carbon dioxide (CO₂) comprising the steps of:
driving a flow of atmospheric air through an interior of tower including drawing the flow of atmospheric air in through an inlet of the tower and out of an outlet of the tower positioned above the inlet and positioning a first heat transfer structure in the interior of the tower closer to the outlet than the inlet whereby the atmospheric air absorbs heat and rises;
spraying a first fluid stream containing K₂CO₃ or other carbonates within the tower such that the first fluid stream comingles with the flow of atmospheric air and captures CO₂ from the flow of atmospheric air; and
defining a first fluid circuit in part by the first heat transfer structure and in part by a second heat transfer structure disposed in a depleted oil well such that at least part of the heat transferred into the interior of the tower is geothermal and drawn from the depleted oil well.

18. The method of claim 17 further comprising the steps of:
separating the captured CO₂ from the first fluid stream; and
directing the captured CO₂ down an active oil well.

19. The method of claim 17 further comprising:
placing the first heat transfer structure and the second heat transfer structure in direct fluid communication with one another, without an intermediate heat transfer structure disposed between the first heat transfer structure and the second heat transfer structure.

20. The method of claim 17 further comprising:
placing a third heat transfer structure intermediate the first heat transfer structure and the second heat transfer structure.
